(19) United States
(12) Patent Application Publication
(10) Pub. No.: US 2014/0182202 A1
(43) Pub. Date: Jul. 3, 2014

(54) SUPPORTIVE DEVICE AND MOUNTING SYSTEM, AND METHOD FOR INSTALLING AND USING THE SAME

(71) Applicant: Eric WILMOT, Litchfield, CT (US)

(72) Inventor: Eric WILMOT, Litchfield, CT (US)

(73) Assignee: Wellspring Systems, LLC, Litchfield, CT (US)

(21) Appl. No.: 13/967,124

(22) Filed: Aug. 14, 2013

Related U.S. Application Data
(60) Provisional application No. 61/683,205, filed on Aug. 14, 2012.

(51) Int. Cl. A01G 9/12; A01G 27/04

(52) U.S. Cl. CPC A01G 9/12; A01G 27/04
USPC 47/81; 29/428; 47/39

(57) ABSTRACT

A supportive device and mounting system for positioning potting or planting systems on a support surface and enabling convenient and secure location, adaptive replacement and optional irrigation use. A base support member is secured to a structural support system. An insert member is adaptive positioned within the based support member enabling a smooth transition to the structural support system. Alternative irrigation systems operably interconnect each base support, member for improved convenience. A method for installing, modifying and operating the supportive device and mounting system is also provided.

### CROSS-REFERENCE TO RELATED APPLICATIONS

The present application claims priority to U.S. provisional patent application Ser. No. 61/683,205 entitled “Supportive Device and Monitoring System, Method, for Installing and Using the Same” filed on Aug. 14, 2012, the entire contents of which is hereby incorporated in reference.

### BACKGROUND OF THE INVENTION

1. Field of the Invention

The present invention relates to a supportive device and mounting system for the same with related methods of use and incorporation with an irrigation system. More particularly, the present invention provides a supportive device and mounting system, in conjunction with an irrigation system securable to a structural, support system with enhanced safety and enabling multiple mounting positions with adaptive features to enhance user convenience. The invention also relates generally to plant support and irrigation systems, and to a system for irrigating plant support systems by capillary action,

2. Description of the Related Art

The conventional art contains potting and planting systems; namely pots for positioning on a support, surface or hanging systems for cantilevered hanging from a window (window pots).

Conventionally, it is also recognized that irrigation systems of large volume flow may be provided to: access the bottom of a planting pot via. either submerging the pot bottom in a water volume or by placing the pot on a wicking surface mat which is itself draped in large water volume proximate the pot These are typically used as seed-cultivating systems of small sizes, or on large-commercial scale water-growing gardens (e.g., lettuce production facilities). Moreover, wick irrigation is a method of litigation applying a fundamental wicking theory to spread water over a semi-permeable medium before entering the soil. In essence, the thatch within grass material acts as a capillary medium to deliver water to a specific region. The capillary action, sometimes referred to as “wicking motion” allows water to rise from a tube located at the plant thatch level and flow outward into the grass thatch and travel along the thatch until it contacts water flowing from another location. At that point, where the flowing water meets, the water stops traveling and infiltrates evenly into the ground. Wick irrigation has a number of advantages. There is zero overhead spray water loss, greater water efficiency and uniformity, little to no run-off and a lower pressure requirement. Widespread implementation of wick irrigation has been met by the difficulties posed in creating an inexpensive, easily modifiable, environmentally responsive system.

Capillary or sub-irrigation beds have been used for many years for watering nursery stock out-of-doors and, in recent years, for greenhouse container plant production. The basic principle of a capillary bed is the capillary rise of water through the growth medium (i.e., soil mix) due to adhesion and cohesion forces, that is, the attraction of water by various surfaces and small spaces (adhesion) and the attraction of water molecules to each other (cohesion). While the system has worked well on a small scale under certain mild climatic conditions, capillary or sub-irrigation bed watering systems have shortcomings, such as cost maintenance, increased water loss, etc.

Unfortunately, each of the conventionally known systems fails to recognize the safety risks of combination with a walking surface or decking surface, and none enable, securely mounting the same thereon.

Accordingly, there is a need for an improved supportive device and mounting system that addresses at least one of the concerns noted above.

### SUMMARY OF TOE INVENTION

It is now recognized that an improved supportive device and mounting system in conjunction with an irrigation system is provided that enables resolution of at least one of the reeds noted above.

The present invention provides a supportive device and mounting system in conjunction with an irrigation system enabling convenient and secure location, adaptive replacement, and optional irrigation use. A base support member is secured to a structural support system. An insert member is adaptively positioned within the based support member enabling a smooth transition to the structural support system. Alternative irrigation systems operably interconnect earn base support member for improved convenience. A method for installing and modifying tie invention is provided.

In another alternative embodiment of the present invention, aspects of the proposed inventive supporting device and mounting system may alternatively be provided in a kit form within a secure container for transportation prior to an installation thereof at a use-location.

In one alternative embodiment of the proposed invention, one or more wire support members may cooperate with a base supporting unit member to enable operative securing of the sane to a structural support system at a use location. In adaptive alternatives thereof the wire support members may be of any shape or composition and may be positioned variously for support without departing from the scope and content of the present invention.

In another alternative embodiment of the proposed system, a flange support, system may cooperate with a base supporting unit member to enable operative seeming of the same to a structural support system at a use location. The flange support system may be of a shape or composition to enable flush mounting, sub-surface mounting, exposed mounting, or other mounting options, and may include ah adaptation for alignment and assembly ease without departing from the scope and spirit of the present invention.

In another alternative embodiment of the proposed system, a flange support system may cooperate with a base supporting unit member to enable operative securing of the same to a structural support system at a use location.

In a further alternative embodiment of the proposed invention, the supporting device may be adaptively provided with a heater, a cooler, an interior fluid circulation pump, a fluid storage medium, and an irrigation access system thereby enabling rapid adaptation to a use-location and a proximate climate therein.

In an alternative embodiment of the present invention, an irrigation system may include one or more supports, bubblers, valves, linkages, and control devices to enable a suitable water supply feed to a base support member and optionally to an insert member according to needs thereof. It will be understood that the irrigation system proposed may be mounted to an exterior of the base support or may pass through the base support and be integrated therewith.

One alternative embodiment of the present invention provides a supportive system, comprising at least one base support member having opposing sides, a closed bottom, and open top and bounding an interior volume; two of said opposing sides proximate respective support side walls of an external structural support system said base support; said two of said opposing sides operably secured to said respective support side walls thereby securing said base support member relative to said external structural support system; an insert member having opposing insert sides, a closed insert bottom, an open insert top and bounding an interior insert volume; and said insert member positioned within said base support unit.

Another alternative embodiment of the present invention further provides a supportive system, further comprising at least one wicking well defined in the insert member proximate the closed insert bottom defining a drainage plane thereon.

Another alternative embodiment of the present invention further provides a supportive system, further comprising a plurality of mating extensions projecting away from an interior surface of selected regions of the opposing sides of the base support member, a plurality of mating grooves defined projecting inwardly from an exterior surface of selected regions of the opposing insert sides of the insert member, and the mating extensions and the mating grooves operably interfitting thereby providing a alignment of the insert member with the base support member.

Another alternative embodiment of the present invention further provides a supportive system, further comprising at least one support structure extending proximate the closed bottom of the base support member and toward the open top thereof.

Another alternative embodiment of the present invention further provides a supportive system, further comprising at least one support surface proximate the closed bottom of the insert member and positioned for operatively engaging the one support structure extending from the base support member, whereby the insert member is operably supported within the base support member during an assembly therewith.

Another alternative embodiment of the present invention, further provides a supportive system, further comprising at least one base support element, the support element on at least one of an Inside surface and an outside surface of at least one of the respective opposing sides of the base support member, each the base support element including a link feature on opposing ends thereof the respective link feature proximate the external structure support system, whereby during an assembly of the system the at least one base support enhances a support of the base support member relative to the external support system.

Another alternative embodiment of the present invention further provides a supportive system, wherein the link feature of each the base support element bounds a bounded opening therethrough.

Another alternative embodiment of the present invention further provides a supportive system, wherein the base support element is on the inside surface of the base support member, and the bounded opening of each the base support element proximate a rim of the open top of the base support element, thereby enabling an external fixing member to be passed through the bounded opening and the rim of the base support element and secure theretogether with the external support system.

Another alternative embodiment of the present invention further provides a supportive system, further comprising at least one means for providing operative irrigation to the wicking well of the insert member, the means for providing operative irrigation including at least one of a sealed and bounded access from an exterior surface of the base support member to an interior surface of the base support unit, the means for providing operative irrigation positioning the sealed and bounded access proximate the closed bottom of the base support member, the sealed and bounded access in operative communication with an external fluid supply, thereby supplying the fluid supply to an interior to the base support member proximate the wicking well of the insert member.

Another alternative embodiment of the present invention further provides a supportive system, further comprising the means for providing operative irrigation to the wicking well of the insert member further comprising at least one irrigation aid, selected from a group of irrigation aids consisting of: a flow regulator, a temperature regulator, a tube support member, a regulator support, a heater system for controlling a temperature of the irrigation, water-fountain feature, and a nutrient access member.

According to another alternative, embodiment of the present invention, there is provided a supportive system kit, comprising a container for operatively containing at least one base support member having opposing sides, a closed bottom, and open top and bounding an interior volume, an insert member having opposing insert sides, a closed insert bottom, an open insert top and bounding an interior insert volume, the insert member including at least one wicking well defined in the insert member proximate the closed insert bottom defining a drainage plane thereon, and at least one base support element.

According to another alternative embodiment of the present invention, there is provided a method for assembling a supportive system, comprising the steps of determining a supportive system location, selecting a base support member, installing a base support member relative to an external structural support system, selecting an insert member an installing the insert member in the base support member, selecting and installing at least one irrigation fitting operative to the base support member, securing the irrigation fitting to an external irrigation system, and operating the supportive system.

It is therefore an object of the present invention to provide a new and improved planting system comprising a base support, an insert member and an irrigation system.

It is another object of the present invention to provide a new and improved system for growing, and irrigating plants in an efficient and inexpensive manner.

A further object or feature of the present invention is a new and improved method for planting and growing plants in an urban area through interconnection to an existing structure.

An even further object of the present invention is to provide a novel planting bed or support system having a plurality of base support members, each having an insert member with capillary and drainage keyways for a wicking action to irrigate the interior of the insert member.

Other novel features, which are characteristic of the invention, as to organization mid method of operation, together with further objects and advantages thereof will be better understood from the following description considered in connection with the accompanying drawings, in which preferred embodiments of the invention are illustrated by way of example. It is to be expressly understood, however, that the drawings are for illustration and description only and are not intended as a definition of the limits of the invention. The various features of novelty which characterize the invention are pointed out with particularity in the claims annexed to and forming part of this disclosure. The invention resides not in any one of these features taken alone, but rather in the particular combination of all of its structures for the functions specified.

There has thus been broadly outlined the more important features of the invention in order that the detailed description thereof that follows may be better understood, and in order that the present contribution to the art may be better appreciated. There are, of course, additional features of the invention that will be described hereinafter and which will form additional subject matter of the claims appended hereto. Those skilled in the art will appreciate that the conception upon which this disclosure is based readily may be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is neither intended to define the invention of this application, which is measured by the claims, nor is it intended to be limiting as to the scope of the invention in any way.

Certain terminology and derivations thereof may be used in the following description for convenience in reference only, and will not be limiting. For example, words such as “upward”, “downward”, “left”, and “right” would refer to directions in the drawings to which reference is made unless otherwise stated. Similarly, words such as “inwardly” and “outwardly” would refer to directions toward and away from, respectively, the geometric center of a device or area and designated parts thereof. References in the singular tense include the plural, and vice versa, unless otherwise noted.

The above and other aspects, features and advantages of the present invention will become apparent from the following description read in conjunction with the accompanying drawings, in which like reference numerals designate the same elements.

### BRIEF DESCRIPTION OF THE DRAWINGS

A further understanding of the present invention can be obtained by reference to a preferred embodiment set forth in the illustrations of the accompanying drawings. Although the illustrated preferred embodiment is merely exemplary of methods, structures and compositions for carrying out the present invention, both the organization and method of the invention, in general, together with further objectives and advantages thereof, may be more easily understood by reference to the drawings and the following description. The drawings are not intended to limit the scope of this invention, which is set forth with particularity in the claims as appended or as subsequently amended, but merely to clarify and exemplify the invention.

For a more complete understanding of the present invention, reference is now made to the following drawings in which:

FIG. 1 is an illustrative schematic of a supportive device and mounting system in accordance with the preferred embodiment of the present invention in an installed use condition following a first step of locate and cut, a second step of installing, and a third step of growing plants therein.

FIG. 2 is an expanded illustrative schematic of an interchangeable insert and a base support member of a supportive device and mounting system installed proximate to a structural support system (shown as a flush mounting on a deck).

FIG. 3 is an exploded perspective view of a supportive system including an alternative base support member, a base support, element, and an insert member.

FIG. 4 is an illustrative cross-sectional view of an installed supportive system depicting a flush-mounting condition.

FIG. 5 is an illustrative view of multiple supportive systems according to the preferred embodiment of the invention in place depleting multiple secured, base support, members.

FIG. 6 is an exploded perspective view of a supportive system including an alternative base support member, a base support element, and an insert member.

FIG. 7 is a partially exploded perspective view of the supportive system of FIG. 6.

FIG. 7A is an exploded bottom perspective view of the supportive system of FIG. 6.

FIG. 8 is an illustrative cross-sectional view of an installed supportive system according to the invention depicting flush-mounting and the interior supportive structures and support surfaces therein.

FIG. 9 is an exploded perspective view of a supportive system according to an alternative embodiment of the present invention depicting a key-together feature of the base support member and insert member during an installation and showing the inter-fitting thereof.

FIG. 10 is partial side perspective view of an insert member being inserted into a base member further showing the interfit between these members through the use of keys and keyways to secure alignment.

FIG. 11 is an exploded perspective view of the proposed structural support system noting adaptively sized insert members securable within a single base support member.

FIG. 12 shows a top perspective view of adaptively sized insert members within a single base support member further to FIG. 11.

FIG. 13 shows an illustrative perspective and cross-sectional view of adaptively sized insert members within a single base support member further to FIG. 11.

FIG. 13A is a cross-sectional view at line 13A-13A through an assembled view of FIG. 13 depicting the support features between the base support member and the individual insert members.

FIG. 14 is an Illustrative cross-sectional view of an assembly of a base support member and an insert member with one alternative irrigation feature passed therethrough.

FIG. 15 is an illustrative cut-away perspective view of the base support member shown in FIG. 14, showing the positioning of the base support members, irrigation features, and support for insert members.

FIG. 16 is an exploded bottom perspective view of a supportive system and an alternative irrigation feature with bottom support and entry with a single return construction.

FIG. 17 is a partial bottom perspective view of the assembled base support of FIG. 16 with the irrigation feature in position.

FIG. 18 is a partial cut-away perspective and exploded view of the assembled base support shown in FIG. 17 depicting the position and internal structures of the alternative irrigation feature of FIGS. 16 & 17.

FIG. 19 is a perspective, exploded view of the alternative irrigation structure shown in FIGS. 16-18, depicting the sealing rings and water-tube interfitting.

FIG. 20 is an illustrative cross-sectional view of the supportive system of FIG. 16 assembled with the alternative irrigation feature installed, depicting an assembly of an insert member positioned and supported within a base support member.

FIG. 21 is a flow chart illustrating the method of installing the supportive system in accordance with the preferred embodiment of the present invention, further depicting a first step of locating a workpiece location and cutting an opening for the supportive system, a second step of installing the supportive system, and a third step of installing an irrigation system and then operating the system to grow plants therein.

### DETAILED DESCRIPTION OF THE PREFERRED EMBODIMENTS

As required, a detailed illustrative embodiment of the present invention is disclosed herein. However, techniques, systems, compositions and operating structures in accordance with the present invention may be embodied in a wide variety of sizes, shapes, forms and modes, some of which may be quite different from those in the disclosed embodiment. Consequently, the specific structural and functional details disclosed herein are merely representative, yet in that regard, they are deemed to afford the best embodiment for purposes of disclosure and to provide a basis for the claims herein which define the scope of the present invention.

Reference will now be made in detail to embodiments of the invention. Wherever possible, same or similar reference numerals are used in the drawings and the description to refer to the same or like parts or steps. The drawings are in simplified form and are not to precise scale. The word ‘couple’ and similar terms do not necessarily denote direct and immediate connections, but also include connections through intermediate elements or devices. For purposes of convenience and clarity only, directional (up/down, etc.) or motional (forward/back, etc.) terms may be used with respect to the drawings. These and similar directional terms should not be construed to limit the scope in any manner, it will also be understood that other embodiments may be utilized without departing from the scope of the present invention, and that the detailed description is not to be taken in a limiting sense, and that elements may be differently positioned, or otherwise noted as in the appended claims without requirements of the written description being required thereto.

Various elements, features and functions or steps may be described, in turn, as multiple discrete elements, features and functions or steps in a manner that may be helpful in understanding embodiments of the present invention; however, the order of description and the tact that elements, features and functions or steps may be combined or joined or separated according to a particular alternative embodiment should not be construed to imply that these exemplary alternative embodiments are limiting on the scope or content of the present invention.

It will be further understood by those of skill in the art having studied the enclosed disclosure that the components herein may be provided in any suitable material for the purpose noted; and these materials may be compositions, plastics, metals, ceramics, rubbers, foams, or any combination thereof, and that the shape and form of the proposed components may be adapted for alternative use in keeping with this invention without exceeding the scope, bounds, and spirit of the present invention.

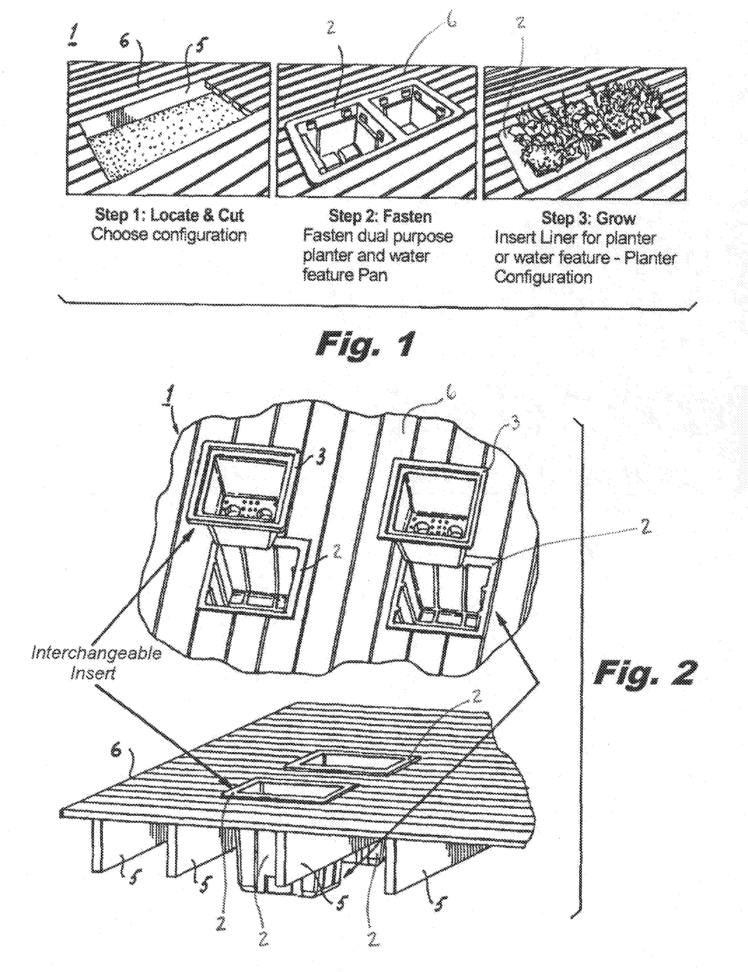

Referring first to FIGS. 1 & 5, shown are exemplary illustrative schematics of a supportive device and mounting system 1 in accordance with the preferred embodiment of the present invention in an installed use condition following a first step of choosing a configuration sad locating and cutting the necessary area on decking system 6 to exposing support joists 5. A second step of fastening a dual purpose planter and water feature pan in accordance with the preferred apparatus of the invention is performed by installing the base support member(s) 2. and optionally securing them to the joists 5 of decking system 6. A third step includes inserting a liner or insert member 3 into the interior volume of base support member 2 to enable the planting and growing of plants therein. As depicted, in greater detail in FIG. 2, shown is an expanded illustrative schematic of the interchangeable insert 3 and a base support member 2 of a supportive device and mounting system 1 installed proximate to a structural support system 6 (shown as a flush mounting on a deck) in accordance with the invention. Importantly, base support members may be securely fastened to joists 5 or may simply lie between respective joists 5 to hold the base support member in place. Also, optionally, base support members may comprise a single piece, two-well unit as depicted in FIG. 1, or may be individual single-well members as seen in FIG. 2.

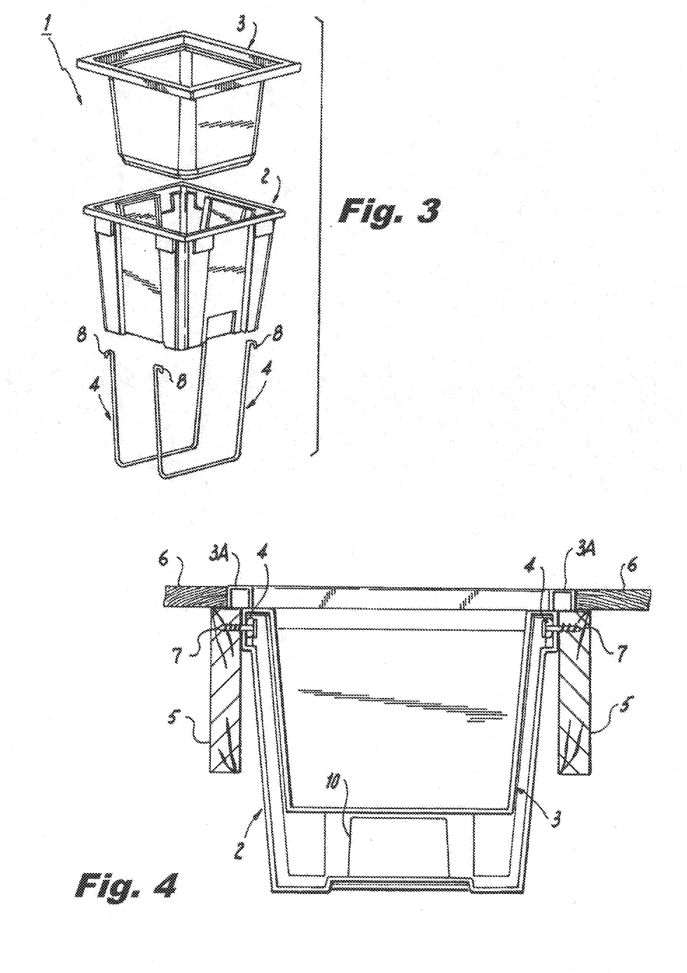

As seen more clearly in FIGS. 3-4, showing an exploded perspective view of a supportive system 1 including an alternative base support member 2, a base support element 4, and an insert member 3, and an illustrative cross-sectional view of an installed supportive system 1 depicting a flush-mounting condition. In particular, an inventive support system 1 is provided with base support member 2 and an insert member 3 shown therein, including an optional and adaptive base support element 4 positioned relative to an external structural support system, shown here with opposing joist members 5, relative to a decking system 6 as will be understood by those of skill in the art.

As shown base support elements 4 interfit on an exterior surface of base support member 2 (or optionally within an interior portion thereof, or further optionally, passing from an exterior to an interior thereof) and include bounded, openings or link regions 8 on opposing ends thereof A plurality of respective screws 7 secure ends to joists 6 and also enable co-support of base support member 2, thereby operatively enabling foil code-support for a weight.

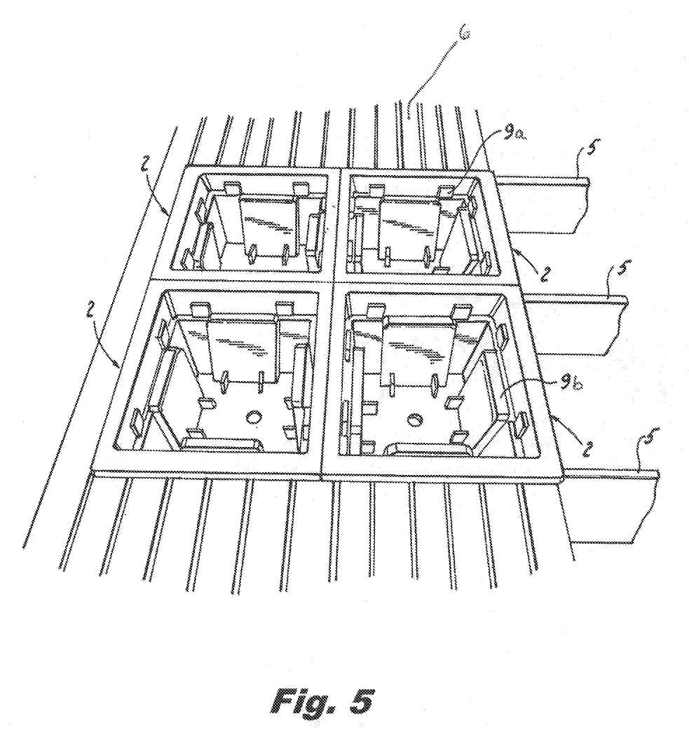

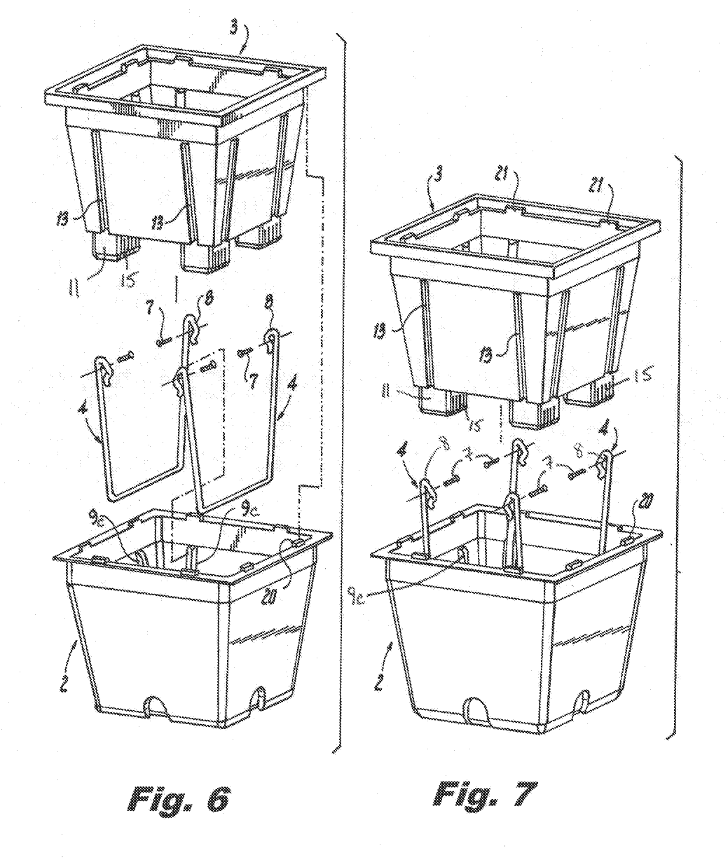

An upper rim 3A on insert member projections and covers a top rim of base support member 2, as shown in FIG. 4, in a flush-mounting condition with decking 6. It will be understood that base support member 2 and insert member 3 with rim 3A may be mounted ‘proud’ or above the surface of decking 6 without departing from the scope and spirit of the present Invention. Also, base support may be securely fastened to joists 5 of decking system 6 by any known fastening means such as a screw 7 as shown or by nails, etc. Screws 7 may then also be utilized to secure base support element 4 via their bounded openings or link regions 8. Base support elements 4 may be used to secure insert members 3 within the interior volume of base support member 2 via receiving slots 13 on insert members 3 (see FIG. 6). Optionally, mating extensions or protrusions 9a-c may be employed to better align and secure insert member 3 within base support member 2 (see FIGS. 5-6).

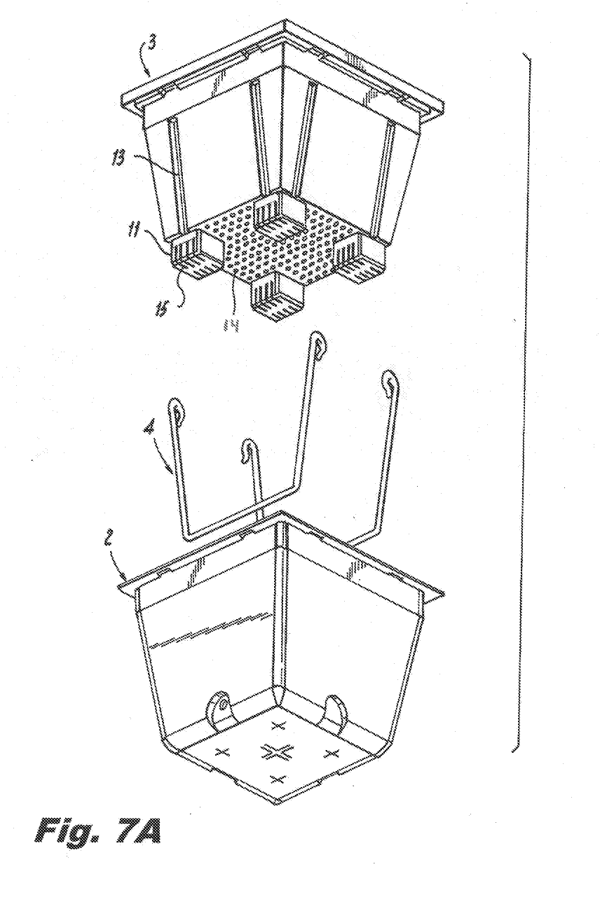

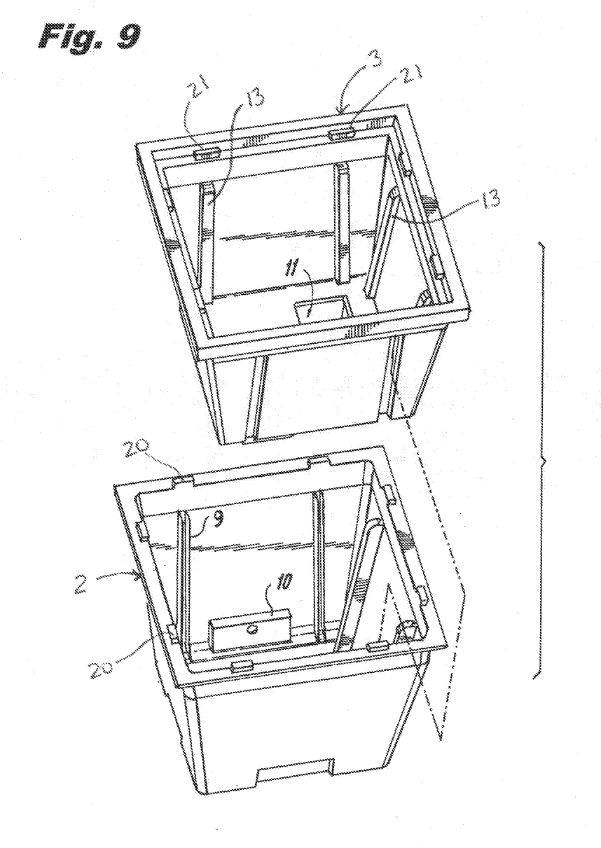

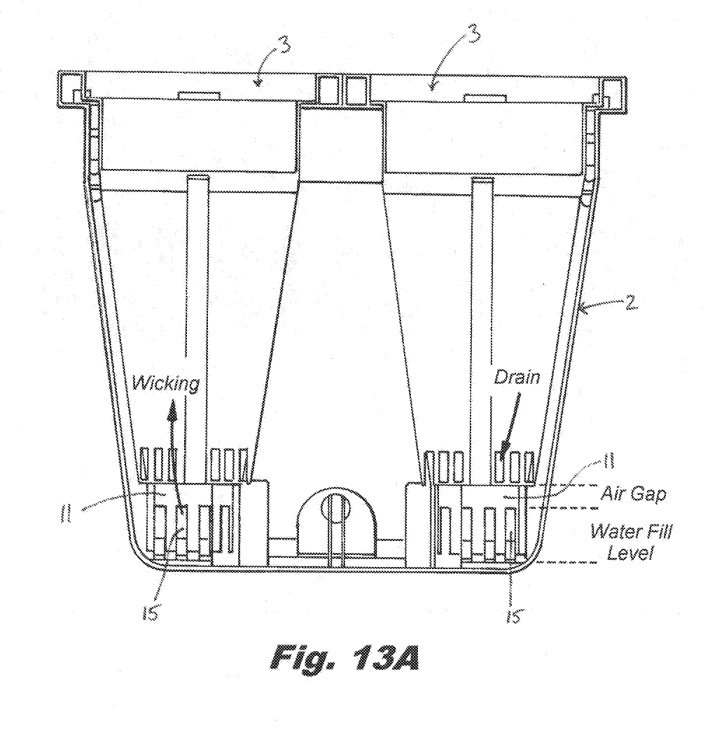

Turning next to FIGS. 6-7A, which show an exploded perspective view, a partially exploded perspective view, and an exploded bottom perspective view of a supportive system 1, depicted is an alternative base support member 2, a base support element 4, an insert member 3, an interior surface of base support member 2 which optionally includes a plurality of formed surfaces or extensions 9c to enable the secure assembly of the supportive system 1 according to the present invention. Optionally, mating extensions 9a-c are included for projecting and contacting an outer surface of insert member 3 for guiding support and alignment. Also optionally provided are a plurality of support structures 10 (see FIGS. 9, 13 & 15) along a bottom location thereof for both supporting and guiding insert members 2 and for supporting insert members 2 above a bottom surface of base support member 2. Conversely, a plurality of receiving slots 13 are optionally positioned on the exterior surfaces of insert members 3 for adaptive cooperative engagement with respective mating extensions 9a-c and/or 10 on respective surfaces. As depicted in FIG. 7A, insert member 3 optionally comprises wicking wells 11 located at the bottom surface of insert member 3. Preferably, each wicking wells 11 further comprise capillary keyways 15 to enable a water pass into and out of insert member 3. Optionally, the bottom surface of insert member 3 may comprise a plurality of drainage openings 14, again to allow the passing of water into and out of insert member 3.

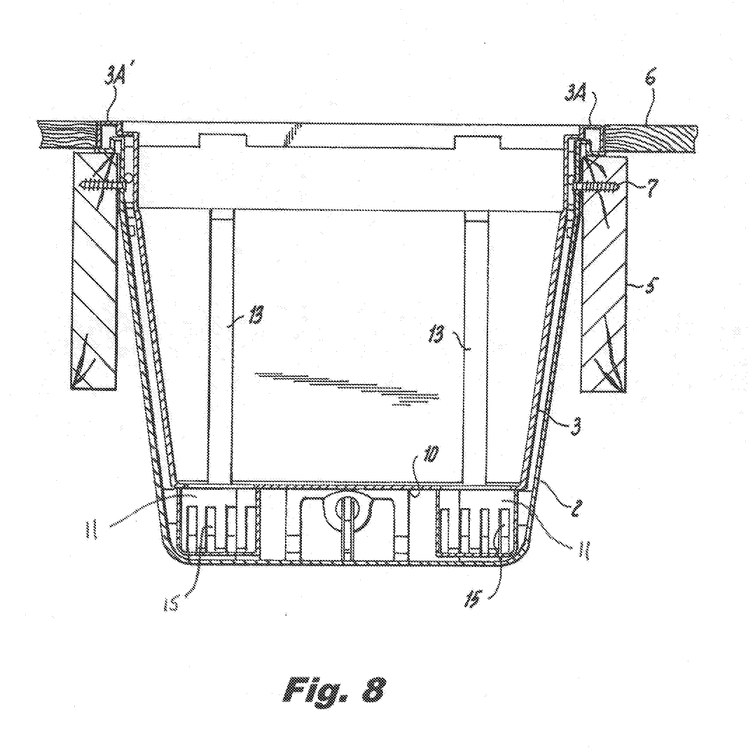

Referring next to FIG. 8, shown is an illustrative cross-sectional view of an installed supportive system 1 according to the invention depicting flush-mounting of rim 3A with decking 6 and the interior supportive structures and support surfaces 10 therein. It will be understood that base support member 2 and insert member 3 with rim 3A may alternatively be mounted above the surface of decking 6 without departing from the scope and spirit of the invention. Also, base support member 2 may be securely fastened to joists 5 of decking system 6 by any known listening means such as screws 7 as shown or by nails, etc. Screws 7 may then also be utilized to secure base support element 4 via their bounded openings or link regions 8.

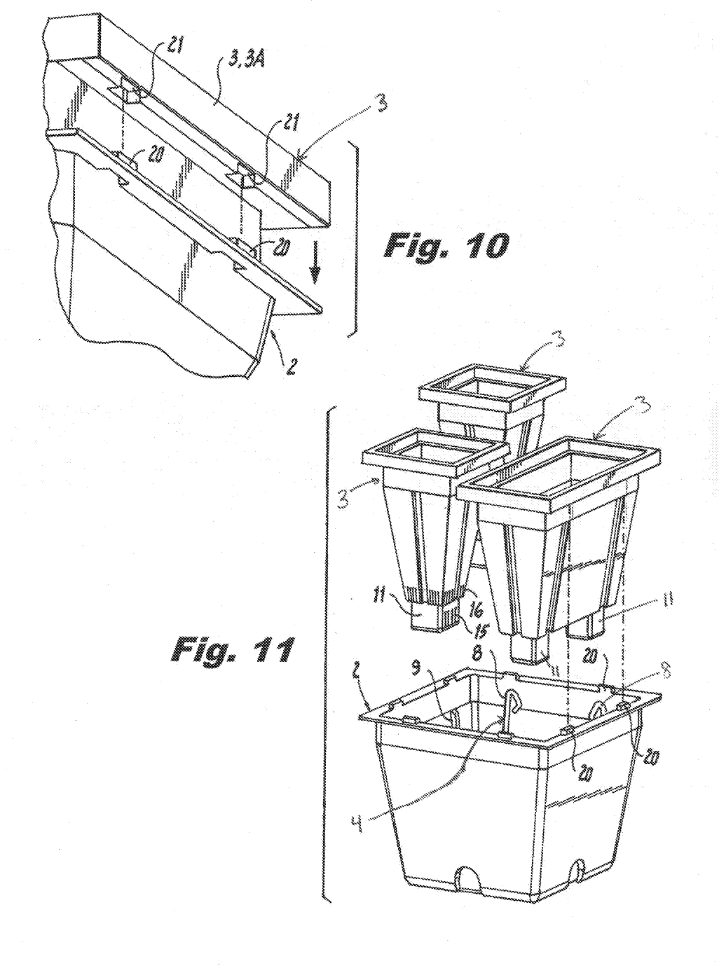

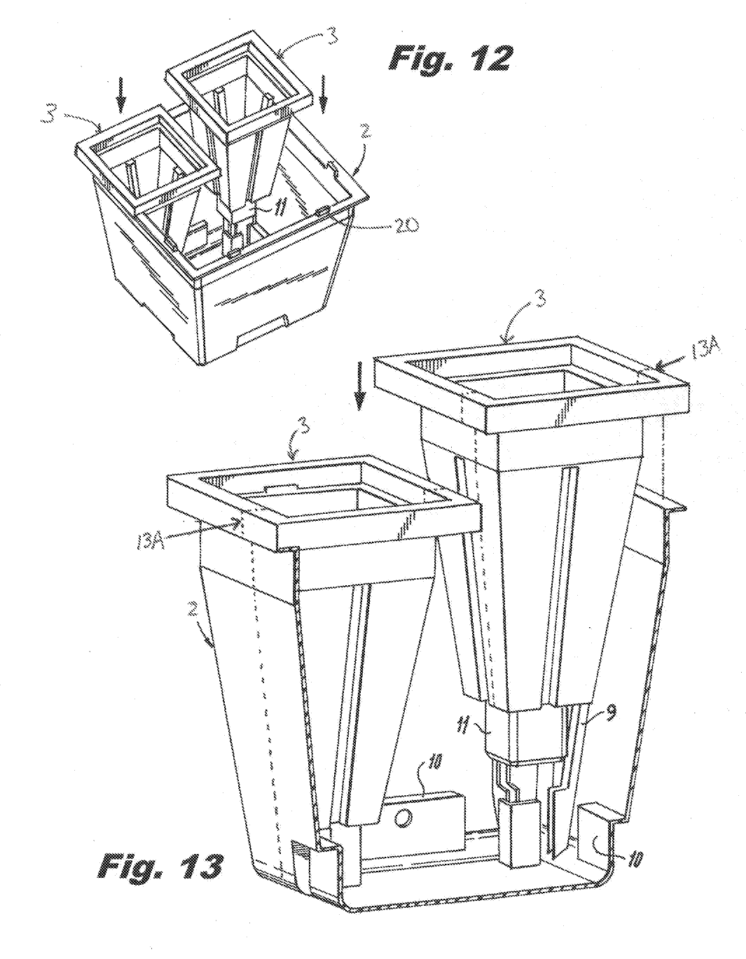

Further referring to FIGS. 9-13, is an exploded perspective view of a supportive system according to an alternative embodiment of the present invention depicting a key-together feature of the base support member and insert member during an installation and showing the inter-fitting thereof. Also shown is a partial side perspective view of an insert member being inserted into a base member further showing the interfit between these members through the use of keys and keyways to secure alignment thereof. Further depicted are exploded perspective views of the proposed structural support system having a plurality of adaptively sized insert members securable within a single base support member in accordance with an alternative embodiment of the invention.

As depicted, each insert member 3 preferably includes a wicking well feature 11 projecting from a bottom thereof below and each for contacting a water level in each base support member during an irrigation thereof. Capillary keyways 15 and drainage keyways 16 join the bottom to enable a water entry to insert member 3 and a water exit from insert member 3, there being an air-gap there between as illustrated in the accompanying images for suitably preventing rotting of the bottom of any planting materials in insert member 3. Furthermore, a plurality of projecting keys 20 may be employed that extend from base support member 2 at a top rim thereof shaped for interfitting with a plurality of receiving key ways 21 on the underside of rim 3A of insert member 3. During use, keys 20 and keyways 21 preferably interfit and secure an alignment therewith.

Accordingly, as depicted, the present invention, provides a supportive device and mounting system 1 in conjunction with an irrigation system 30 enabling convenient and secure location, adaptive replacement, and optional irrigation use thereof. A base support member 2 is secured to a structural support system 6. An insert member 3 is adaptively positioned within the base support member 2 enabling a smooth transition to the structural support system 6. Alternative irrigation systems 30 operably interconnect each base support member 2 for improved convenience. Such a supporting device and mounting system may alternatively be provided in a kit form within a secure container for transportation prior to an installation thereof at a use-location. Further provided in the supportive system 1 is at least one wicking well 11 defined in the insert member 3 proximate to the closed insert bottom defining a drainage plane thereon.

In an alternative embodiment of the proposed invention, one or more wire support members 4 may cooperate with a base supporting member 2 to enable operative securing of the same to a structural support system 6 at a use location via fasteners 7. Such wire support members 4 may be of any shape or composition and may be positioned variously for support without departing from the scope of the present invention. Also, a flange support system 3A may cooperate with a base supporting member to enable operative securing of the same to a structural support system 6 at a use location. The flange support system 3A may be of a shape or composition to enable flush mounting, sub-surface mounting, exposed mounting, or other mounting options, and may include an adaptation for alignment and assembly ease. Optionally, the supporting device 1 may be adaptively provided with a heater, a cooler, an interior fluid circulation pump, a fluid storage medium, and an irrigation access system thereby enabling rapid adaptation to a use-location and a proximate climate therein.

In still another alternative embodiment of the present invention, an irrigation system 30 may include one or more supports 35, bubblers, valves, linkages, and control devices to enable a suitable water supply feed 31, 32 to a base support member 2 and optionally to an insert member 3 according to needs thereof. It will be understood that the irrigation system proposed may be mounted to an exterior of the base support or may pass through the base support member 2 and be integrated therewith.

Optionally, a plurality of mating extensions 9a-c projecting away from an interior surface of selected regions of the opposing sides of the base support member 2 are provided. Similarly, a plurality of mating grooves 13 defined projecting inwardly from an exterior surface of selected regions of the opposing Insert sides of the insert member 3 are provided. The mating extensions 9a-c and the mating grooves 13 operably interfit thereby providing alignment of the insert member 3 with the base support member 2.

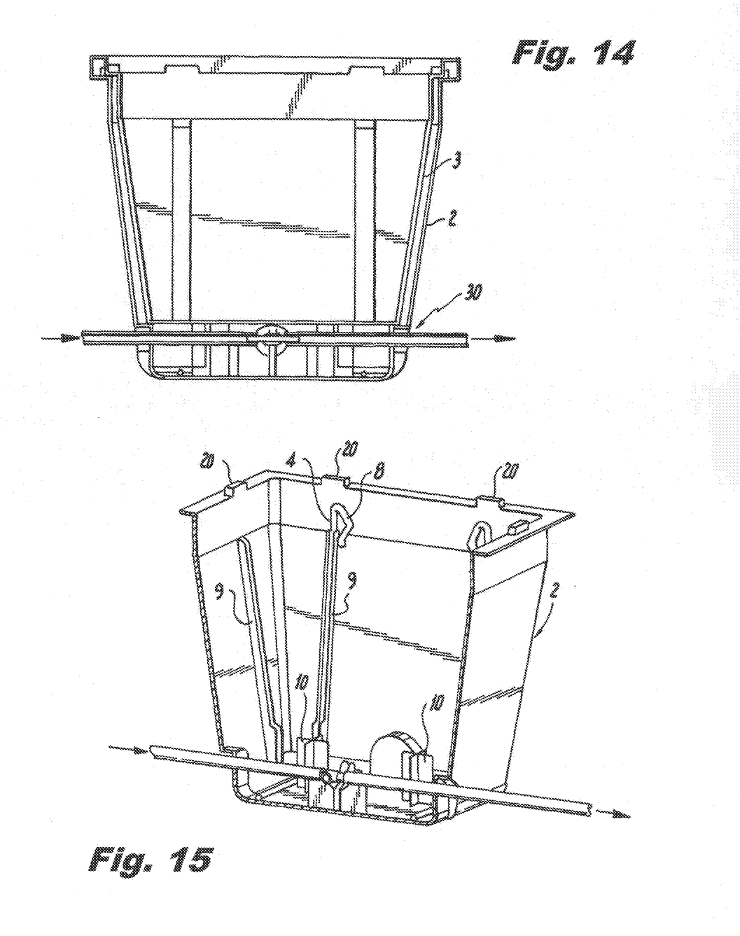

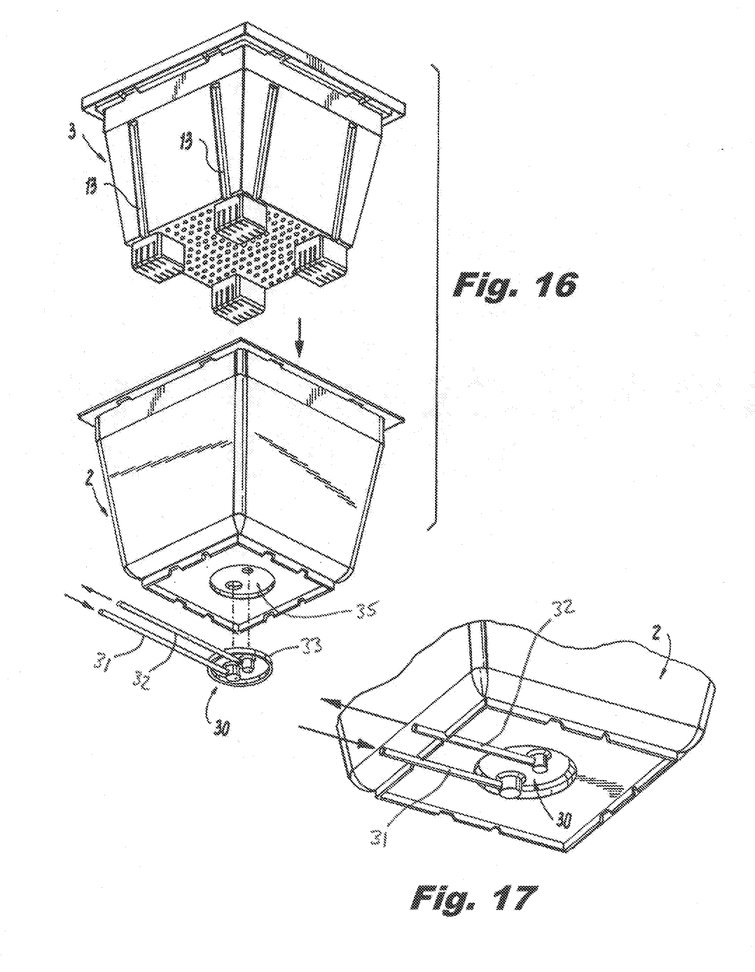

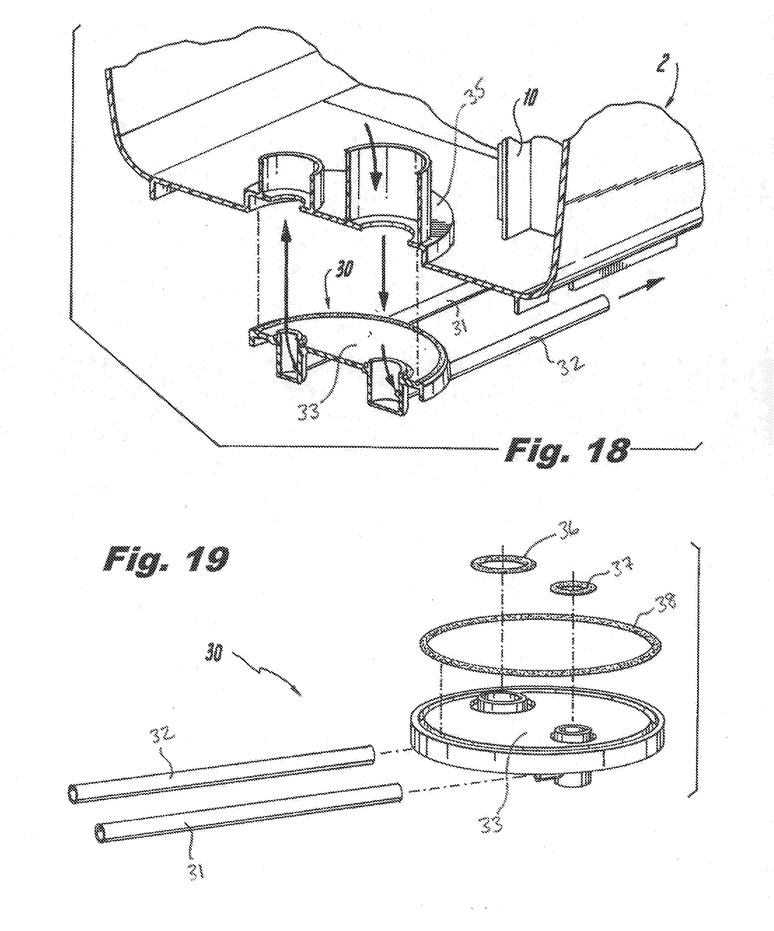

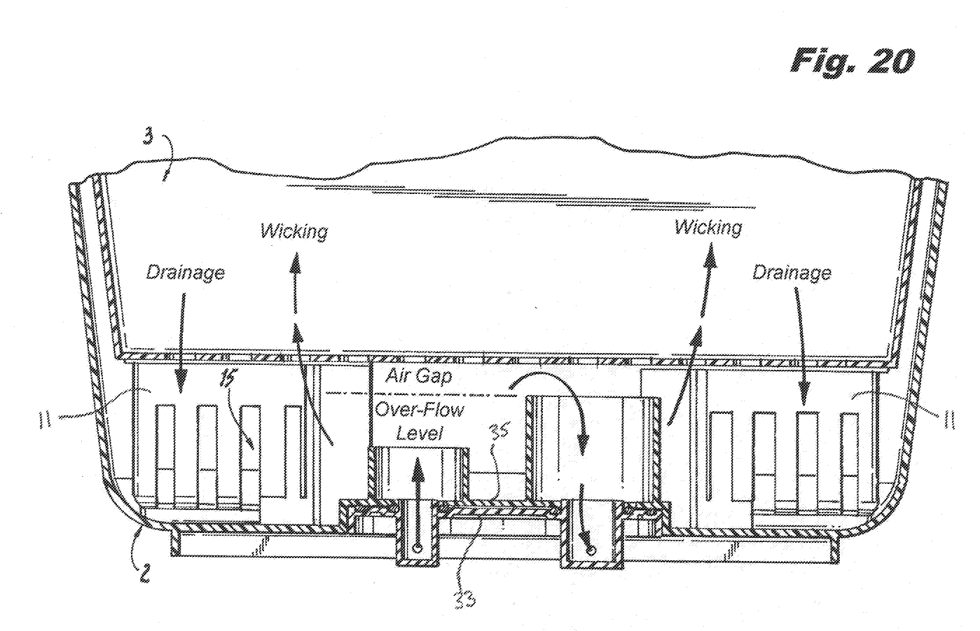

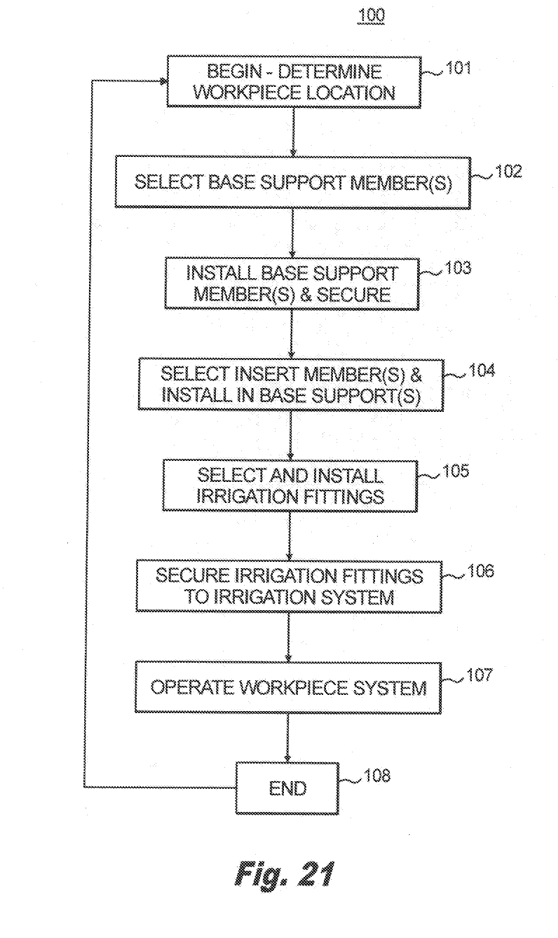

As will also be noted in the figures, an irrigation fitting device or system 30 is illustrated plurality of irrigation elements depicted particularly in FIGS. 14-20. As is noted, these features are either mountable on a bottom surface of base support members 2, or may be interfitted therewith. As will also be noted, base support members are particularly shaped and sized for fitting between conventionally positioned joist members 5 (for operate convenience). Thusly, insert, members 3 may be variously sized to fit such 16×16 inch openings and may be themselves sub-units thereof, for example 4×16, 4×4, etc, while not departing from the scope and spirit of the present invention. It will also be understood, that as used herein the phrases ‘wicking’ ‘draining’ ‘capillary action’ or so forth, are illustrative words for general fluid flow principals, and as such are understood by those of skill in the relative arts.

Referring lastly to FIG. 21, shown is a flow chart illustrating the method of installing 100 the supportive system in accordance with the preferred embodiment of the present invention. A first step 101 of choosing a configuration and locating and cutting the necessary area on decking system 6 to exposing support joists 5 is performed. Next, base support members are selected 102 relative to an external structural support system. Next, the base support member is installed 103 relative to an external structural support system. An insert member is then selected and installed 104 within the interior volume of the base support member. At least one irrigation fitting is selected and installed 105 so as to be in communication with the base support member such that it may provide irrigation to the interior volume of the base support member. Once installed, the irrigation fittings are secured to a selected irrigation system 106 to provide the necessary water flow to the base support member. Once the irrigation system 30 is connected, the system may be operated 107, and ended when no more water is desired 108. This method may be repeated as often as is needed depending on the number of base support members used and the particular need for water or irrigation in the particular systems.

Accordingly, as shown in FIG. 21, provided is a method for assembling a supportive system comprising the steps of determining a supportive system location 101, selecting a base support member 102, installing a base support member relative to an external structural support system 103, selecting an insert member and installing the insert member in the base support member 104, selecting and installing at least one irrigation fitting operative to the base support member 105, securing the irrigation fitting to an external irrigation system 106, and operating the supportive system 107.

In the claims, means or step-plus-function clauses are intended to cover the structures described or suggested herein as performing the recited function and not only structural equivalents but also equivalent structures. Thus, for example, although a nail, a screw, and a bolt may not be structural equivalents in that a nail relies on friction between a wooden part and a cylindrical, surface, a screw's helical surface positively engages the wooden part, and a bolt's head and nut compress opposite sides of a wooden part, in the environment of fastening wooden parts, a nail, a screw, and a bolt may be readily understood by those skilled In the art as equivalent structures.

Having described at least one of the preferred embodiments of the present invention with reference to the accompanying drawings sufficient to enable one of ordinary skill in the art to practice the invention, and to provide the best mode of practicing the invention presently contemplated by the inventor, it is to be understood that such embodiments are merely exemplary and that the invention is not limited to those precise embodiments, and that various changes, modifications, and adaptations may be effected therein by one skilled in the art without departing from the scope or spirit of the invention as defined in the appended claims. Accordingly, the disclosed embodiments are not mutually exclusive combinations of features; rather, the invention may comprise a combination of different individual features selected from different individual embodiment, as understood by persons of ordinary skill in the art. The scope of the invention, therefore, shall be defined solely by the appended claims.

Further, while there is provided herein a full and complete disclosure of the preferred embodiments of this invention, it is not desired to limit the invention to the exact construction, dimensional relationships, and operation shown and described. Various modifications, alternative constructions, changes and equivalents will readily occur to those skilled in the art and may be employed, as suitable, without departing from the true spirit and scope of the invention. Such changes might involve alternative materials, components, structural arrangements, sizes, shapes, forms, functions, operational features or the like, it will be apparent to those of skill in the art that numerous changes may be made in such details without departing from the spirit and the principles of the invention, it should be appreciated that the present invention is capable of being embodied in other forms without, departing from its essential characteristics.

What is claimed is:

1. A supportive system for positioning potting or planting systems on a support surface, said system comprising:
at least one base support member having a plurality of opposing sides, a closed bottom, and an open top, said opposing sides and said closed bottom bounding an interior volume;
at least two said opposing sides being proximate to support side walls of an external structural support system for said base support member;
said at least two said opposing sides operably secured to said support side walls thereby securing said base support member relative to said external structural support system;
an insert member having a plurality of opposing insert sides, a closed insert, bottom, and an open insert top, said opposing insert sides and said closed insert, bottom bounding an interior insert volume; and
said insert member positionable within said base support member.

2. The system according to claim 1, wherein said insert member comprises at least one wicking well proximate said closed insert bottom.

3. The system according to claim 2, further comprising:
at least one irrigation means for providing operative irrigation to said wicking well of said insert member;
wherein said irrigation means includes at least one of a sealed access or a and bounded access from an exterior surface of said base support member to an interior surface of said base support member;
wherein said irrigation means positions at least one of said sealed access or said bounded access proximate said closed bottom; and
wherein at least one of said sealed access or said hounded access is in operative communication with an external fluid supply thereby supplying fluid from said fluid supply to said interior volume proximate said wicking well of said insert member.

4. The system according to claim 3, wherein said irrigation means further comprises at least one irrigation aid, selected from a group of irrigation aids consisting of a flow regulator, a temperature regulator, a rube support member, a regulator support, a heater system for controlling a temperature of said irrigation, water-fountain feature, fuel-cell fireplace feature, and a nutrient access member.

5. The system according to claim 1, wherein said base support member comprises a plurality of mating protrusions projecting away from an interior surface of selected regions of said opposing sides;
wherein said insert member comprises a plurality of mating grooves projecting inwardly from an exterior surface of selected regions of said, opposing insert sides; and
wherein select ones of said mating protrusions operably interfit with respective ones of said mating grooves.

6. The system according to claim 1, further comprising;
at least one base support element extending proximate said closed bottom of said base support member and toward said open top.

7. The system according to claim 6, further comprising:
at least one support surface proximate said closed bottom of said insert member and positioned for operatively engaging said one support element extending from said base support member, whereby said insert member is operably supported within said base support member.

8. The system, according claim 1, further comprising:
at least one base support element;
wherein said base support element is configured on at least one of an inside surface and an outside surface of at least one of said respective opposing sides;
wherein each said base support element includes a link feature on opposing ends thereof;
wherein said respective link feature is proximate said external structure support system; and
wherein during an assembly of said system said at least one base support element enhances support of said base support member relative to said external support system.

9. The system according to claim 8, wherein said link feature of each said base support element bounds to a bounded opening for engaging an exterior surface of said base support member.

10. The system according to claim 9, wherein said base support element is positioned on said inside surface of said base support member; and
wherein each said bounded opening is proximate a rim of said open top of said base support element, thereby enabling an external fixing member to be passed through said bounded opening and said rim and secure said base support member with said external support system.

11. A kit for a supportive system for positioning potting or planting systems on a support surface, said kit comprising:
a container for operatively containing:
at least one base support member having opposing sides, a closed bottom, and open top and bounding an interior volume;
an insert member having opposing insert sides, a closed insert bottom, an open insert top and bounding an interior insert volume, wherein said Insert member includes at least one wicking well defined in said insert member proximate said closed insert bottom defining a drainage plane thereon;
at least one base support element; and
at least one irrigation fitting for providing irrigation to said interior volume of said base support member.

12. The kit according to claim 11, wherein said insert member comprises at least one wicking well proximate said closed insert bottom.

13. The kit according to claim 11, wherein said base support member comprises a plurality of mating protrusions projecting away from an interior surface of selected regions of said opposing sides;
wherein said Insert: member comprises a plurality of mating grooves projecting inwardly from an exterior surface of selected regions of said opposing insert sides; and
wherein select ones of said mating protrusions operably interfit with respective ones of said mating grooves.

14. The kit according to claim 11, wherein said at least one base support element extends proximate said closed bottom of said base support member and toward said open top.

15. The kit according to claim 14, further comprising:
at least one irrigation means for providing operative irrigation to said wicking well of said insert member;
wherein said irrigation means includes at least one of a sealed access or a bounded access from an exterior surface of said, base support member to an interior surface of said base support member;
wherein said irrigation means positions at least one of said sealed access or said bounded access proximate said closed bottom; and
wherein at least one of said sealed access or said bounded access is in operative communication with an external fluid supply thereby supplying fluid from said fluid supply to said interior volume proximate said wicking well of said insert member.

16. A method for assembling a supportive system for positioning potting or planting systems on a support surface, said method comprising the steps of:
determining a location for establishing a supportive system;
installing a base support member relative to an external structural support system, said base support member having a plurality of opposing sides, a closed bottom, and an open top, said opposing sides and said closed bottom bounding an interior volume;
installing an insert member within said interior volume of said base support member;
installing at least one irrigation fitting in communication with said base support member;
securing said irrigation fitting to an external irrigation system for providing irrigation to said interior volume of said base support member; and
operating said supportive system.

17. The method according to claim 16, wherein said insert member comprises at least one wicking well proximate said closed insert bottom.

18. The method according to claim 17, said method further comprising the step of:
connecting to said wicking well of said insert member at least one irrigation means for providing operative irrigation;
wherein said irrigation means includes at least one of a sealed access or a bounded access from an exterior surface of said base support member to an interior surface of said base support member;
wherein said irrigation means positions at least one of said sealed access or said bounded access proximate said closed bottom; and
wherein at least one of said sealed access or said bounded access is in operative communication, with an external fluid supply thereby supplying fluid from said fluid supply to said interior volume proximate said wicking well of said insert member.

19. The method according to claim 16, wherein said base support member comprises a plurality of mating protrusions projecting away from an interior surface of selected regions of said opposing sides;
wherein said insert member comprises a plurality of mating grooves projecting inwardly from an exterior surface of selected regions of said opposing insert sides; and
wherein select ones of said mating protrusions operably interfit with respective ones of said mating grooves.

20. The method according to claim 16, said method further comprising the step of:
installing at least one base support element extending proximate said closed bottom of said base support member and toward said open top.
